(19) United States
(12) Patent Application Publication
(10) Pub. No.: US 2019/0066203 A1
(43) Pub. Date: Feb. 28, 2019

(54) SYSTEMS AND METHODS FOR VERIFICATION OF INCOME

(71) Applicant: Finicity Corporation, Murray, UT (US)

(72) Inventors: Steven B. Smith, Murray, UT (US); Nicholas Thomas, Murray, UT (US)

(21) Appl. No.: 16/051,737

(22) Filed: Aug. 1, 2018

Related U.S. Application Data
(60) Provisional application No. 62/549,995, filed on Aug. 25, 2017.

(51) Int. Cl. G06Q 40/02

(52) U.S. Cl. CPC G06Q 40/025

(57) ABSTRACT

Systems and methods for rapidly verifying income are disclosed.

### CROSS-REFERENCED APPLICATIONS

This application claims priority to U.S. Provisional Patent Application No. 62/549,995 titled “Systems and Methods for Verification of Income,” filed Aug. 24, 2017.

### BACKGROUND OF THE INVENTION

### 1. Field of the Invention

The present invention relates to verification of income, and more particularly to systems and methods for providing rapid and accurate verification of income in the context of loan approval.

### 2. Background and Related Art

Traditionally, in the credit industry, it is common for lenders to use a variety of methods to verify borrowers' creditworthiness prior to issuing new credit. This is particularly true in the area of mortgage lending given the often large sums involved in mortgage lending. One of the primary ways in which lenders ascertain and/or verify borrowers' creditworthiness is by way of obtaining FICO (originally Fair, Isaac and Company) scores that are calculated based on a variety of credit data in the borrowers' credit reports maintained by the major credit reporting agencies (e.g., Experian, Equifax, and/or TransUnion). FICO scores are calculated based on factors such as amounts owed, payment history, new credit, length of credit history, and mix of credit. FICO scores have been used by lenders such as Fannie Mae and Freddie Mac for a number of years.

While FICO scores are generally helpful in evaluating borrowers' creditworthiness, difficulties remain in evaluating creditworthiness solely using FICO scores or equivalent measurements. For example, different credit agencies may have different information regarding borrowers' credit, and may provide different FICO scores. Similarly, any FICO score is, by necessity, at best only an approximation of borrowers' creditworthiness. The difficulties are such that as many as approximately 30% of borrowers that are approved using FICO scores eventually default on the loans for which they were approved. In addition to the borrowers for whom the FICO score represents an overestimation of creditworthiness (leading to an increased risk of default), it is recognized that for some borrowers, the FICO score represents an underestimation of creditworthiness. For this reason, many lenders allow borrowers to demonstrate their creditworthiness through one or more alternate paths when the lenders would be unwilling to extend credit based on the FICO score alone.

Another problem exists, however, for borrowers and lenders in such situations. Generally, the alternate methods by which a borrower can demonstrate creditworthiness are burdensome on both the borrower and the lender. The borrower is burdened in that the borrower typically needs to accumulate and provide significant evidence of creditworthiness (in the form of evidence of income, evidence of assets, evidence of payment history, evidence of other debts, etc.). Similarly, the potential creditor is burdened in evaluating all of this evidence and ensuring that all applicable evidence and information has been properly disclosed.

Still other difficulties are encountered by would-be borrowers that use less credit than average, relying instead on cash and cash instruments such as checks, and debit cards. It is a long-recognized problem in the lending industry that such individuals do not establish a credit history of the type traditionally captured and evaluated by traditional credit reports and credit scores, making it more difficult for lenders to evaluate the creditworthiness of such would-be borrowers.

Currently, despite significant advancements in computer systems and in the information that is potentially available to assist lenders in evaluating borrowers' creditworthiness, significant barriers remain to improving creditors' ability to evaluate their borrowers' creditworthiness. The difficulties are evidenced by creditors continuing to refuse to extend credit to borrowers who would be able to satisfy their loan obligations, as well as by the ongoing high rate of default on loans that are extended from lenders to borrowers. The difficulties are further evidenced by the procedures implemented under the Fair Credit Reporting Act (FCRA), which allows consumers to dispute or correct inaccurate information contained in their credit reports.

### BRIEF SUMMARY OF THE INVENTION

Implementation of the invention provides systems and methods for rapidly verifying income of a consumer or other borrower. In many instances, the rapid income verification occurs in the context of evaluating creditworthiness of the consumer when considering approval of a loan to the consumer. According to implementations of the invention, a method for providing an accurate evaluation of a borrower's creditworthiness includes the steps of using a network-connected income-verification server to establish a consumer communicative connection with a consumer computing device operated by a consumer and using the communicative connection with the consumer computing device to send an authorization request to the consumer computing device. The authorization request may include a request for information identifying a payroll provider of the consumer, a request for user identification and password information to permit the income-verification server to connect to a payroll provider account associated with the consumer, and a request for authorization to use the user identification and password information to access the payroll provider account.

The method also includes a step of receiving payroll provider information, user identification and password information and authorization to use the user identification and password information to access the payroll provider account from the consumer computing device over the consumer communicative connection or through other communication means and destinations the response to the request may be sent to the requestor, or others authorized by the requestor. The income-verification server establishes a payroll provider communicative connection with a payroll provider server operated by the payroll provider of the consumer as identified by the payroll provider information, inputs the user identification and password information to the payroll provider server to electronically access the payroll provider account associated with the consumer, obtains, from the payroll provider account associated with the consumer, payroll information for the consumer, and uses the payroll information for the consumer to establish or verify an income of the consumer.

Because the income of the consumer is verified from a trusted third-party source, a loan approval or disapproval associated therewith can be of increased accuracy as opposed to relying on representations by the would-be borrower or as opposed to relying on copies of documentation of income that may have been doctored.

The payroll information for the consumer may be information contained on a paystub of the consumer. The payroll information for the consumer may include payroll information for a plurality of pay periods. The payroll information for the consumer may include net income and gross income paid to the consumer during a pay period. The pay stub is scanned using OCR software and digitized for digital transfer.

The authorization request to the consumer computing device may also include a request for information identifying a financial institution receiving a direct deposit of payroll from the payroll provider, a request for financial institution identification and password information to permit the income-verification server to connect to a financial institution account associated with the consumer, and a request for authorization to use the financial institution identification and password information to access the financial institution account. The method may further include a step of receiving information identifying the financial institution receiving the direct deposit of payroll from the payroll provider, financial institution identification and password information, and authorization to use the user financial institution identification and password information to access the financial institution account. The income-verification server establishes a financial institution communicative connection with a financial institution server operated by the financial institution receiving the direct deposit of payroll from the payroll provider, inputs the financial institution identification and password information to the financial institution server to electronically access the financial institution account associated with the consumer, obtains, from the financial institution account associated with the consumer, information identifying net pay received at the financial institution from the payroll provider for the consumer, and uses the payroll information for the consumer obtained from the from the payroll provider server and the information identifying net pay received at the financial institution to verify that net income reported by the payroll provider matches net income received at the financial institution.

According to further implementations of the invention, a method for providing an accurate evaluation of a borrower's creditworthiness, includes steps of using a network-connected income-verification server to establish a consumer communicative connection with a consumer computing device operated by a consumer and using the communicative connection with the consumer computing device to send an authorization request to the consumer computing device. The authorization request may include a request for a copy of a pay stub of the consumer, a request for information identifying a financial institution receiving a direct deposit of payroll from the payroll provider, a request for financial institution identification and password information to permit the income-verification server to connect to a financial institution account associated with the consumer, and a request for authorization to use the financial institution identification and password information to access the financial institution account.

The method also includes receiving the copy of the pay stub of the consumer, the information identifying the financial institution, the financial institution identification and password information and authorization to use the financial institution identification and password information to access the financial institution account from the consumer computing device over the consumer communicative connection. The income-verification server uses an OCR digitized version of the physical paystubs to determine a net pay amount and a pay date associated with the pay stub, establishes a financial institution communicative connection with a financial institution server operated by the financial institution, inputs the financial institution identification and password information to the financial institution server to electronically access the financial institution account associated with the consumer, and obtains, from the financial institution account associated with the consumer, deposit transaction information for the consumer. The deposit transaction information is used to verify the net pay amount and the pay date associated with the pay stub. Other data may be available and is collected such as the frequency of deposits, the length of time that regular deposits have been made, variances in the amount of the deposits and whether the user has other accounts at that financial institution.

The method may also include identifying a payment frequency from the pay stub and using the deposit transaction information to verify multiple deposits associated with payroll of the consumer. The income-verification server may determine information from the copy of the pay stub such as net pay, gross pay, frequency of pay, account deposited to, employer name, and consumer name.

The copy of the pay stub may be a PDF of the pay stub. The copy of the pay stub may be an image of the pay stub or an OCR digitized version of the pay stub.

In another implementation, either the employer, the payroll provider, or a data steward, e.g. an issuer, creates a digital identifier with a public private key pair that represents a relationship with a consumer. The issuer would then create and digitally sign a digital income verification object such as a paystub, employment verification object, or similar such as a salary verification object and deliver that object to a digital wallet owned by the consumer. The lender, employer, or requestor would then request access to the credential from the consumer through their wallet to verify income or employment.

Further implementation of the invention includes systems, including computer systems, configured to perform any of the methods discussed above as well as computer-readable media containing computer program code to cause a computer system to implement any of the methods discussed above.

If the applicant has more than one regular source of income of if a couple have jointly applied, then the gathered income information may be aggregated and a report sent to the requestor and in some cases also to the applicant.

The financial institution may also be queried on verification of identity and how long the account has been active. A report is then formulated and is sent to the requestor or others authorized by the requestor. The report may be delivered to a CPA portal for access by the requestor or others.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use in accordance with embodiments of the invention;

FIG. 2 shows a representative networked computer system for use in accordance with embodiments of the invention;

FIG. 3 shows a representative networked computer environment used in conjunction with embodiments of the invention;

FIG. 4 shows a flow chart in accordance with embodiments of the invention; and

FIG. 5 shows a flow chart in accordance with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for rapidly verifying income of a consumer or other borrower. In many instances, the rapid income verification occurs in context of evaluating creditworthiness of the consumer in the context of considering approval of a loan to the consumer. According to embodiments of the invention, a method for providing an accurate evaluation of a borrower's creditworthiness includes steps of using a network-connected income-verification server to establish a consumer communicative connection with a consumer computing device operated by a consumer and using the communicative connection with the consumer computing device to send an authorization request to the consumer computing device. The authorization request may include a request for information identifying a payroll provider of the consumer, a request for user identification and password information to permit the income-verification server to connect to a payroll provider account associated with the consumer, and a request for authorization to use the user identification and password information to access the payroll provider account.

The method also includes a step of receiving payroll provider information, user identification and password information and authorization to use the user identification and password information to access the payroll provider account from the consumer computing device over the consumer communicative connection. The income-verification server establishes a payroll provider communicative connection with a payroll provider server operated by the payroll provider of the consumer as identified by the payroll provider information, inputs the user identification and password information to the payroll provider server to electronically access the payroll provider account associated with the consumer, obtains, from the payroll provider account associated with the consumer, payroll information for the consumer, and uses the payroll information for the consumer to establish or verify an income of the consumer.

Because the income of the consumer is verified from a trusted third-party source, a loan approval or disapproval associated therewith can be of increased accuracy as opposed to relying on representations by the would-be borrower or as opposed to relying on copies of documentation of income that may have been doctored.

The payroll information for the consumer may be information contained on a paystub of the consumer. The payroll information for the consumer may include payroll information for a plurality of pay periods. The payroll information for the consumer may include net income and gross income paid to the consumer during a pay period.

The authorization request to the consumer computing device may also include a request for information identifying a financial institution receiving a direct deposit of payroll from the payroll provider, a request for financial institution identification and password information to permit the income-verification server to connect to a financial institution account associated with the consumer, and a request for authorization to use the financial institution identification and password information to access the financial institution account. The method may further include a step of receiving information identifying the financial institution receiving the direct deposit of payroll from the payroll provider, financial institution identification and password information, and authorization to use the user financial institution identification and password information to access the financial institution account. The income-verification server establishes a financial institution communicative connection with a financial institution server operated by the financial institution receiving the direct deposit of payroll from the payroll provider, inputs the financial institution identification and password information to the financial institution server to electronically access the financial institution account associated with the consumer, obtains, from the financial institution account associated with the consumer, information identifying net pay received at the financial institution from the payroll provider for the consumer, and uses the payroll information for the consumer obtained from the from the payroll provider server and the information identifying net pay received at the financial institution to verify that net income reported by the payroll provider matches net income received at the financial institution.

According to further embodiments of the invention, a method for providing an accurate evaluation of a borrower's creditworthiness, includes steps of using a network-connected income-verification server to establish a consumer communicative connection with a consumer computing device operated by a consumer and using the communicative connection with the consumer computing device to send an authorization request to the consumer computing device. The authorization request may include a request for a copy of a pay stub of the consumer, a request for information identifying a financial institution receiving a direct deposit of payroll from the payroll provider, a request for financial institution identification and password information to permit the income-verification server to connect to a financial institution account associated with the consumer, and a request for authorization to use the financial institution identification and password information to access the financial institution account.

The method also includes receiving the copy of the pay stub of the consumer, the information identifying the financial institution, the financial institution identification and password information and authorization to use the financial institution identification and password information to access the financial institution account from the consumer computing device over the consumer communicative connection. The income-verification server uses the copy of the pay stub to determine a net pay amount and a pay date associated with the pay stub, establishes a financial institution communicative connection with a financial institution server operated by the financial institution, inputs the financial institution identification and password information to the financial institution server to electronically access the financial institution account associated with the consumer, and obtains, from the financial institution account associated with the consumer, deposit transaction information for the consumer. The deposit transaction information is used to verify the net pay amount and the pay date associated with the pay stub.

The method may also include identifying a payment frequency from the pay stub and using the deposit transaction information to verify multiple deposits associated with payroll of the consumer. The income-verification server may determine information from the copy of the pay stub such as net pay, gross pay, frequency of pay, account deposited to, employer name, and consumer name.

The copy of the pay stub may be a PDF of the pay stub. The copy of the pay stub may be an image of the pay stub.

Further embodiments of the invention include systems, including computer systems, configured to perform any of the methods discussed above as well as computer-readable media containing computer program code to cause a computer system to implement any of the methods discussed above.

While embodiments of the invention are disclosed in which information is requested by an income-verification server from a consumer computing device, additional embodiments of the invention obtain similar information from additional sources. For example, the information of any example discussed above may be received at a lender computer system and forwarded to the income-verification server instead of being received from a consumer computer system. Accordingly, the lender computer system may either serve as an intermediary between the borrower computer system and the income-verification server 50, or may serve as a direct input source of the requested information.

In additional embodiments of the invention, an initial request for information from the income-verification server may be reversed such that a lender sends a request to perform income verification and includes the necessary information to permit execution of the other steps of the method without requiring a step of sending a request for information/authorization. Alternatively, methods may include hybrid methods in which the lender or the consumer initiates a request for income verification and submits some portion of the needed information with the request, and the income-verification server returns a request for additional information necessary to complete the method.

In still other embodiments, methods may be performed in which multiple smaller requests for necessary information are sent instead of a single request for all necessary information. Accordingly, it should be understood that the methods described herein are intended to be illustrative, rather than restrictive.

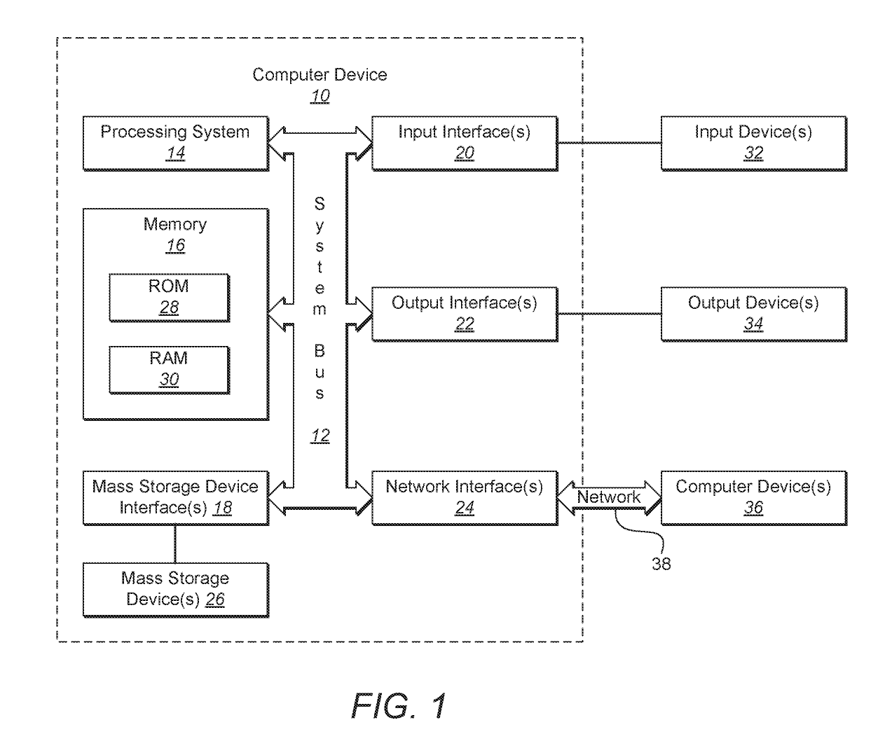

As embodiments of the invention are adapted for implementation in conjunction with various computer systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a fire wire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

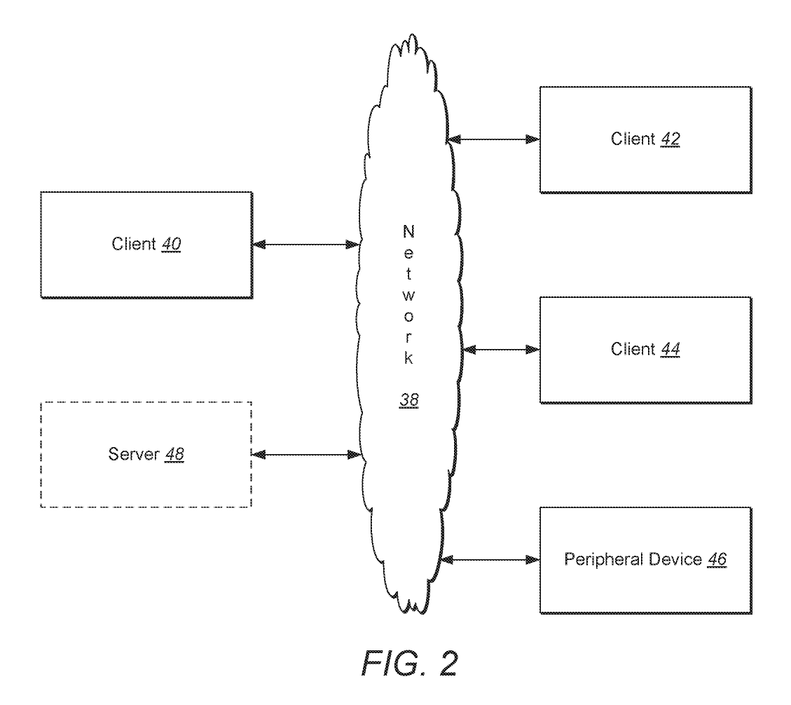

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48 connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

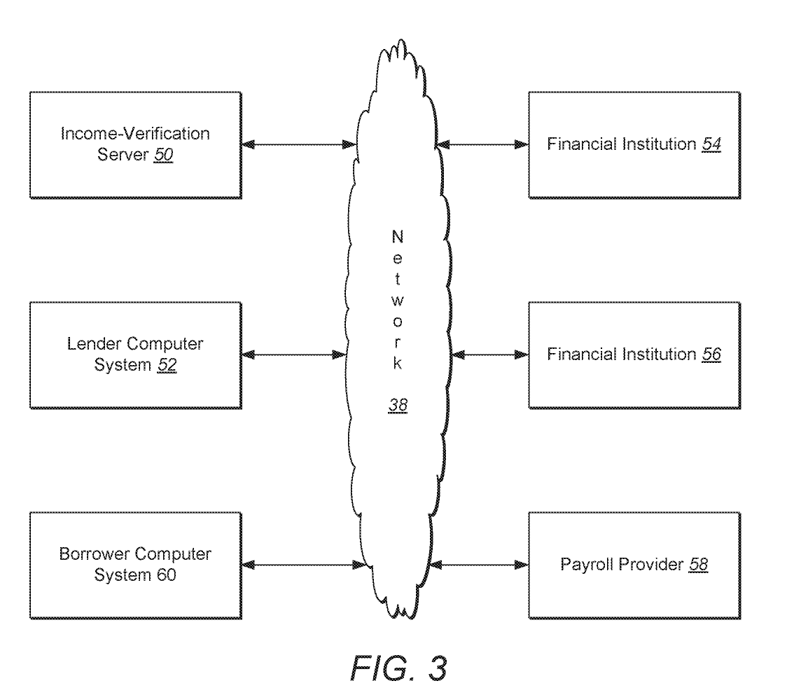

FIG. 3 illustrates a specific illustrative networked computer embodiment in accordance with certain embodiments of computer systems in which embodiments of the invention may be implemented or practiced. In FIG. 3, the network 38 (e.g., the Internet) connects a variety of computer systems and servers together, including an income-verification server 50. The income-verification server is illustrated as a single server system, but it will be appreciated that the income-verification server 50 may actually be implemented as a variety of computer systems and servers functioning as one functional unit, and as used herein, the term “server” is intended to embrace a variety of computer systems functioning a single server unit, including distributed computer systems functioning as a single server unit.

Also connected to the network is a lender computer system 52. The lender computer system 52 may be any computer system from a personal computing device such as a mobile phone, laptop, desktop, or the like, up to a lender server system such as that of the income-verification server 50. The lender computer system 52 is typically used by a lender in conjunction with processing loan applications received from a borrower, in sending requests to the income-verification provider to verify borrowers' creditworthiness, and in receiving evaluations or reports of borrowers' creditworthiness from the income-verification provider.

FIG. 3 also illustrates two financial institutions being connected to the network 38, namely financial institution 54 and financial institution 56. FIG. 3 further illustrates a payroll provider 58 being connected to the network 38. While two financial institutions and one payroll provider are illustrated in FIG. 3, it should be appreciated that embodiments of the invention may be practiced in conjunction with any number of financial institutions and any number of payroll providers, from one up to as many financial institutions and/or payroll providers as may exist at any one point in time. Each financial institution and/or payroll provider operates one or more computer systems that are operatively or communicatively connected to the network 38 and that can provide information about the financial institutions' accounts and transactions and/or pay events/pay stubs to the income-verification server 50 over the network 38. The financial institutions maintain information regarding their customers' financial accounts and transactions. The payroll providers maintain information regarding employees' paychecks, such as gross pay, deductions, net pay, direct deposit information, account paid to, pay date, employee identification, and the like.

When the methods discussed herein are performed, the income-verification server 50 establishes one or more communicative connections with the financial institutions (e.g., their own computer systems or servers) and/or the payroll providers (e.g., their own computer systems or servers), uses consumer identification and password information (login information) to access the respective system, and obtains relevant electronic information in accordance with the applicable method, such as payroll/paycheck information and/or direct deposit information.

In some embodiments, the income-verification server 50 and the lender computer system 52 may be a single logical computing device. In other words, in some embodiments the income-verification server 50 may be provided and maintained by an income-verification provider that is separate and apart from a lender seeking verification of creditworthiness of a particular borrower. In other embodiments, however, the lender may provide its own income verification processes, and accordingly the lender computer system 52 may perform the income-verification steps performed by the income-verification server 50 in other embodiments of the methods.

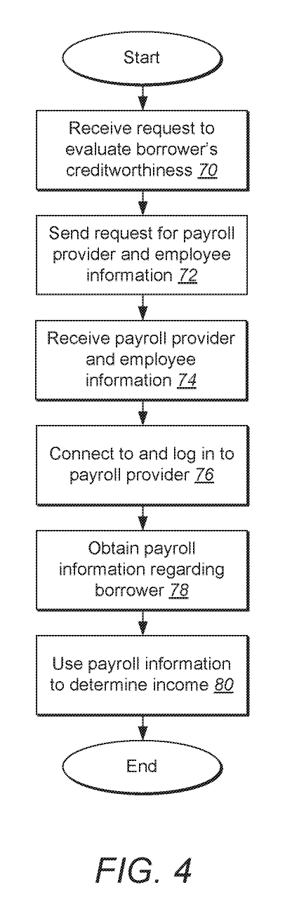

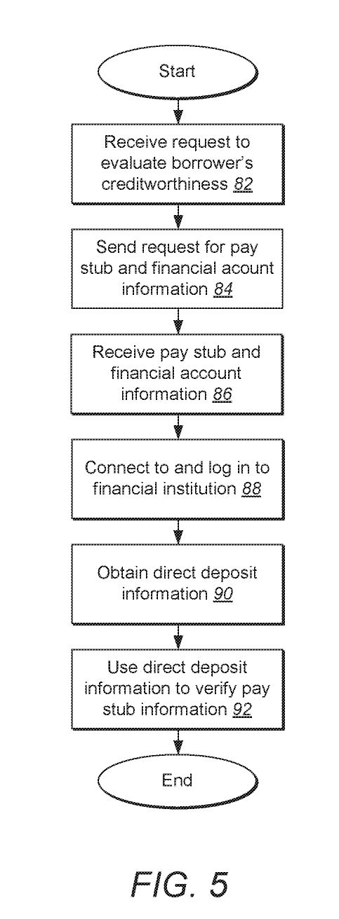

FIGS. 4 and 5 illustrate methods in accordance with certain embodiments of the invention. It should be understood that the illustrated methods are intended to be for illustrative discussion purposes and that alternate embodiments omitting or adding steps may be provided and be embraced by the scope of the appended claims.

Execution of the method of FIG. 4 begins at step 70, where a system receives a request to evaluate a borrower's creditworthiness. For example, the request may be initiated by a would-be borrower, or by a lender who has received a loan application from a would-be borrower. At step 72, a request is sent to obtain payroll provider and employee information. This information may include information identifying a payroll provider and/or a portal to log in to the payroll provider, as well as information permitting a login on behalf of the employee to the payroll provider. At step 74, the necessary information is received by the system. In the event the system determines that the information is incomplete or invalid, steps 72 and 74 may be repeated as necessary until sufficient and valid information is received.

At step 76, the system connects to and logs in to the payroll provider system using the would-be borrower's information. In this way, the system obtains access to the borrower's payroll information, including one or more electronic pay stubs. Accordingly, at step 78, the system obtains payroll information regarding the borrower. Because this information is obtained from a trusted third party, it is deemed reliable in evaluating the income of the borrower. Thus, at step 80, the payroll information is used in whole or in part to determine the borrower's income as a part of or proxy for evaluating the creditworthiness of the borrower.

In certain embodiments of the invention, the method of FIG. 4 may be further enhanced by obtaining information regarding the borrower's financial institution or institutions where the borrower's payroll is direct deposited. The system may log in to the financial institution system and may verify that net pay amounts included in the payroll provider information were actually received at the financial institution and that such amounts match as expected, further strengthening the evidence of the borrower's income.

The method of FIG. 5 begins at step 82, with receipt of a request to evaluate a borrower's creditworthiness. In this method, the borrower may not have access to a payroll provider portal, but may still wish to obtain rapid evaluation of income as part of a creditworthiness determination. Execution proceeds to step 84, where a request is sent for a copy of the borrower's pay stub and financial account information (e.g., financial institution and login information). At step 86, the pay stub copy (e.g., an image from a camera, a PDF, or any other suitable copy of the pay stub) is received along with the financial account information.

At step 88, the system connects to and logs in to the financial institution, thus gaining access to information regarding the borrower's financial accounts and transactions contained therein. At step 90, the system uses this access to obtain direct deposit information. At step 92, the direct deposit information is correlated to the information on the pay stub, thereby verifying through a trusted third party (the financial institution) that the pay stub information is correct and accurate, and has not been subject to forgery or other deception. A report is formulated and digitally sent or otherwise made accessible to the borrower, the lender and/or others authorized to view the report.

In another implementation, either the employer, the payroll provider, or a data steward, e.g. an issuer, creates a digital identifier with a public private key pair that represents a relationship with a consumer. The issuer would then create and digitally sign a digital income verification object such as a paystub, employment verification object, or similar such as a salary verification object and deliver that object to a digital wallet owned by the consumer. The lender, employer, or requestor would then request access to the credential from the consumer through their wallet to verify income or employment.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for providing an accurate evaluation of a borrower's creditworthiness, comprising:
using a network-connected income-verification server to establish a consumer communicative connection with a consumer computing device operated by a consumer;
using the communicative connection with the consumer computing device to send an authorization request to the consumer computing device, the authorization request comprising:
a request for information identifying a payroll provider of the consumer;
a request for user identification and password information to permit the income-verification server to connect to a payroll provider account associated with the consumer; and
a request for authorization to use the user identification and password information to access the payroll provider account;
receiving payroll provider information, user identification and password information and authorization to use the user identification and password information to access the payroll provider account from the consumer computing device over the consumer communicative connection;
using the income-verification server to establish a payroll provider communicative connection with a payroll provider server operated by the payroll provider of the consumer as identified by the payroll provider information;
using the income-verification server to input the user identification and password information to the payroll provider server to electronically access the payroll provider account associated with the consumer;
obtaining, from the payroll provider account associated with the consumer, payroll information for the consumer; and
using the payroll information for the consumer to establish an income of the consumer.

2. The method as recited in claim 1, wherein the payroll information for the consumer comprises information contained on a paystub of the consumer.

3. The method as recited in claim 1, wherein the payroll information for the consumer comprises payroll information for a plurality of pay periods.

4. The method as recited in claim 1, wherein the payroll information for the consumer comprises net income and gross income paid to the consumer during a pay period.

5. The method as recited in claim 1, wherein the authorization request to the consumer computing device further comprises:
a request for information identifying a financial institution receiving a direct deposit of payroll from the payroll provider;
a request for financial institution identification and password information to permit the income-verification server to connect to a financial institution account associated with the consumer; and
a request for authorization to use the financial institution identification and password information to access the financial institution account.

6. The method as recited in claim 5, further comprising:
receiving information identifying the financial institution receiving the direct deposit of payroll from the payroll provider, financial institution identification and password information, and authorization to use the user financial institution identification and password information to access the financial institution account;
using the income-verification server to establish a financial institution communicative connection with a financial institution server operated by the financial institution receiving the direct deposit of payroll from the payroll provider;
using the income-verification server to input the financial institution identification and password information to the financial institution server to electronically access the financial institution account associated with the consumer;
obtaining, from the financial institution account associated with the consumer, information identifying net pay received at the financial institution from the payroll provider for the consumer; and
using the payroll information for the consumer obtained from the from the payroll provider server and the information identifying net pay received at the financial institution to verify that net income reported by the payroll provider matches net income received at the financial institution.

7. A method for providing an accurate evaluation of a borrower's creditworthiness, comprising:
obtaining a pay stub from a borrower;
scanning the pay stub to digitize the information on the pay stub;
using a communicative connection with a consumer computing device to send an authorization request to the consumer computing device, the authorization request comprising:
a request for a copy of a pay stub of the consumer;
a request for information identifying a financial institution receiving a direct deposit of payroll from the payroll provider;
a request for financial institution identification and password information to permit the income-verification server to connect to a financial institution account associated with the consumer; and
a request for authorization to use the financial institution identification and password information to access the financial institution account;
receiving the copy of the pay stub of the consumer, the information identifying the financial institution, the financial institution identification and password information and authorization to use the financial institution identification and password information to access the financial institution account from the consumer computing device over the consumer communicative connection;
using income-verification server and the copy of the pay stub to determine a net pay amount and a pay date associated with the pay stub;
using the income-verification server to establish a financial institution communicative connection with a financial institution server operated by the financial institution;
using the income-verification server to input the financial institution identification and password information to the financial institution server to electronically access the financial institution account associated with the consumer;
obtaining, from the financial institution account associated with the consumer, deposit transaction information for the consumer; and
using the deposit transaction information to verify the net pay amount and the pay date associated with the pay stub.

8. The method as recited in claim 7, further comprising:
identifying a payment frequency from the pay stub; and
using the deposit transaction information to verify multiple deposits associated with payroll of the consumer.

9. The method as recited in claim 7, wherein the income-verification server determines information from the copy of the pay stub selected from the group consisting of net pay, gross pay, frequency of pay, account deposited to, employer name, and consumer name.

10. The method as recited in claim 7, wherein the copy of the pay stub comprises a PDF of the pay stub.

11. The method as recited in claim 7, wherein the copy of the pay stub comprises an image of the pay stub.

12. A system for verifying income comprising:
creating a digital identifier with a public/private key pair that represents a relationship with a consumer;
creating and signing a digital income verification object;
associating the digital income verification object with the digital income verification object;
delivering the digital identifier to a digital wallet owned by the consumer; and
the consumer granting access to the digital identifier in the digital wallet so that a requestor of access may use the digital identifier to verify income or employment.
